(19) United States
(12) Patent Application Publication
(10) Pub. No.: US 2006/0020784 A1
(43) Pub. Date: Jan. 26, 2006

(54) Certificate based authorized domains

(76) Inventors: Willem Jonker, EINDHOVEN (NL); Robert Koster, Eindhoven (NL); Petrus Lenoir, Eindhoven (NL); David Schmalz, Lausanne (CH)

Correspondence Address: PHILIPS INTELLECTUAL PROPERTY & STANDARDS, P.O. BOX 3001, BRIARCLIFF MANOR, NY, 10510, US

(21) Appl. No.: 10/528,492

(22) PCT Filed: Sep. 17, 2003
(86) PCT No.: PCT/IB03/04052

§ 371 Date: Mar. 18, 2005

(30) Foreign Application Priority Data
Sep. 23, 2002 (EP) 02078892.3
Mar. 25, 2003 (EP) 03100772.7

(51) Int. Cl. H04L 9/00

(52) U.S. Cl. 713/157

(57) ABSTRACT

The present invention relates to a method, a system and a central device for secure content distribution among devices in a network. The invention is based on the idea that an authorized domain is set up with a central device administering the network. When a device enters the network, the central device registers the entering device and issues at least one certificate to the entering device. The registration to ensure that the entering device is an authorized device, meaning that an authorized device manufacturer has provided the device. Due to network security, non-authorized devices are not accepted in the network. Content is distributed among the devices in the network based on authentication by means of the at least one certificate issued to each device. The distribution of content from a first device to a second device is enabled by the first device authenticating the second device, by means of the at least one certificate of the second device and vice versa.

### TECHNICAL FIELD OF THE INVENTION

The present invention relates to a method, a system and a central device for secure content distribution among devices in a network.

### INTRODUCTION TO THE INVENTION

In recent years, the amount of content protection systems is growing in a rapid pace. Some of these systems only protect the content against illegal copying, while others are also prohibiting the user to get access to the content. The first category is called Copy Protection (CP) systems. CP systems have traditionally been the main focus for consumer electronics (CE) devices, as this type of content protection is thought to be cheaply implemented and does not need bidirectional interaction with the content provider. Some examples are the Content Scrambling System (CSS), the protection system of DVD ROM discs and DTCP, the protection system for IEEE 1394 connections.

The second category is known under several names. In the broadcast world, systems of this category are generally known as conditional access systems, while in the Internet world they are generally known as Digital Rights Management (DRM) systems.

Some type of CP systems can also provide services to interfacing conditional access or DRM systems. Examples are the systems currently under development by the DVB-CPT subgroup and the TV-Anytime RMP group. The goal is a system in which a set of devices can authenticate each other through a bidirectional connection. Based on this authentication, the devices will trust each other and this will enable/allow them to exchange protected content. The accompanying licenses describe which rights the user has and what operations he is allowed to perform on the content. The license is protected by means of some general network secret, which is only exchanged between the devices within a certain household. This network of devices is called an Authorized Domain (AD).

The concept of authorized domains tries to find a solution to both serve the interests of the content owners (that want protection of their copyrights) and the content consumers (that want unrestricted use of the content). The basic principle is to have a controlled network environment in which content can be used relatively freely as long as it does not cross the border of the authorized domain. Typically, authorized domains are centered around the home environment, also referred to as home networks. Of course, other scenarios are also possible. A user could for example take a portable television with him on a trip, and use it in his hotel room to access content stored on his Personal Video Recorder at home. Even though the portable television is outside the home network, it is a part of the user's authorized domain.

A home network can be defined as a set of devices that are interconnected using some kind of network technology (e.g. Ethernet, IEEE 1394, BlueTooth, 802.11b, . . . ). Although network technology allows the different devices to communicate, this is not enough to allow devices to interoperate. To be able to do this, devices need to be able to discover and address the functions present in the other devices in the network. Such interoperability is provided by home networking middleware (HN-MW). Examples of home networking middleware are Jini, HAVi, UPnP, AVC.

From a HN-MW point of view, systems related to handling secure content appear in several ways. Certain functions in the network require access to protected content. Other functions in the network provide functionality that can be used by the elements in the network handling content security. Furthermore, security frameworks like OPIMA can use the HN-MW to locate each other and communicate in an interoperable way. Of course authorized domains can also be implemented in other ways.

For a more extensive introduction to the use of DRM in home networks, see F. L. A. J. Kamperman, S. A. F. A. van den Heuvel, M. H. Verberkt, Digital Rights Management in Home Networks, Philips Research, The Netherlands, IBC 2001 conference publication vol. I, pages 70-77, and S. A. F. A. van den Heuvel, W. Jonker, F. L. A. J. Kamperman, P. J. Lenoir, Secure Content Management in Authorized Domains, Philips Research, The Netherlands, IBC 2002 conference publication, pp 467-474.

Various systems already exist that implement the concept of authorized domains to some extent. Examples of such systems are SmartRight (Thomson Multimedia), xCP (4C, mainly IBM), and NetDRM (Matshushita).

### SUMMARY OF THE INVENION

It is an object of the invention to provide an Authorized Domain (AD) management mechanism in a DRM system that supports:
Creation and Setting up of an AD
Verification of AD device compliancy
Verification of AD membership
Secure handling of content and rights transport
Secure handling of content and rights (local) storage

The object of the invention is attained by a method for secure content distribution among devices in a network according to claim 1, a system for secure content distribution among devices in a network according to claim 8 and a central device for administrating a network according to claim 15.

According to a first aspect of the invention, a method is provided in which a device entering the network is registered, by means of a central device administrating the network and at least one certificate is issued from the central device to the entering device. According to a second aspect, the method also comprises the step of distributing content among devices in the network based on authentication by means of the at least one certificate issued to each device, wherein the distribution of content from a first device to a second device is enabled by the first device authenticating the second device by means of the at least one certificate of the second device and the second device authenticating the first device by means of the at least one certificate of the first device.

According to a third aspect of the invention, a system is provided in which a central device, which device administrates the network, is arranged to register a device entering the network and to issue at least one certificate to the entering device. The system further comprises at least one certificate, wherein distribution of content among devices in the network is based on authentication by means of the at least one certificate issued to each device, the distribution of content from a first device to a second device being enabled by the first device authenticating the second device by means of the at least one certificate of the second device and the second device authenticating the first device by means of the at least one certificate of the first device.

According to a fourth aspect of the invention, a central device for administrating a network is arranged in the network. The central device comprises means arranged to register a device entering the network and means arranged to issue at least one certificate to the entering device.

The invention is based on the idea that an authorized domain, i.e. a controlled network, is set up with a central device administering the network. When a device enters the network, the central device registers the entering device and issues at least one certificate to the entering device if registration is successful. The registration ensures that the entering device is an authorized device, meaning that an authorized device manufacturer has provided the device. Due to network security, non-authorized devices are not accepted in the network. Content is distributed among the devices in the network based on authentication by means of the at least one certificate issued to each device. The distribution of content from a first device to a second device is enabled by the first device authenticating the second device, by means of the at least one certificate of the second device. Further, the second device authenticates the first device by means of the at least one certificate of the first device.

This concept is advantageous since the devices will, under assumption that they are authorized, trust each other and this enables them to exchange content. The content can be used rather freely as long as it remains within the frames of the network. This prevents content from being distributed to unauthorized devices and content originating from untrusted devices to enter the network. By employing the present invention, it is ensured that an untrusted third party can not make unauthorized copies of a content using a malicious device. A device is only allowed to enter the network if it was produced by an authorized manufacturer. Devices can check that they belong to the same network be checling their respective certificate.

The invention mainly characterizes itself through the use of a specific certificate chain that governs device compliancy, domain (de)registration and domain creation. This specific set-up, in combination with the strict separation between content and licenses, also allows a large number of domain operations without interference of the domain manager, and as such supports different distribution schemes, such as for example super distribution.

In a working AD implementation, at least the following points must be solved:
1. AD creation
2. Entity check-in/check-out (an entity can be a user, a device, a content, a right or a medium).
3. AD security features for content and right exchanges
4. DRM functionalities

The AD creation is the action by which a new AD is created. The entity check-in/check-out is the action by which a new entity can enter/leave the AD. The AD security features relate to all the means that are necessary to ensure a sufficient security level in the AD. The DRM functionalities are the rules, which govern content use and right exchanges within the AD and between different ADs. This invention provides solutions for all these points.

According to an embodiment of the invention, the at least one certificate comprises a first certificate comprising a public key generated by the central device and a signature created with a device private key. The at least one certificate further comprises a second certificate comprising a public key of the entering device and a signature created with a private key generated by the central device, the private key generated by the central device corresponding to the public key generated by the central device. This embodiment has the advantage that content distribution and processing can be effected among devices without participation of the central device, once the certificates have been distributed to the concerned devices. As a result, there is no risk that a heavily loaded central device will become a distribution bottleneck. This embodiments also has the advantage that the private key generated by the central device is stored at the central device only, as opposed to other solutions which require distribution of a shared secret among the devices. This decreases the number of points of failure, and thus contributes to an increase of the overall system security.

According to another embodiment of the invention, the registration of a device entering the network is performed by verifying a third certificate with a device public key stored in each device. The third certificate is factory installed and signed with a certificate authority private key and verification is performed by means of a factory installed corresponding certificate authority public key. The device public key is used to authenticate a device storing a device private key, the device private key corresponding to the device public key. This embodiment is advantageous since device compliancy is checked when a device enters the network using a small number of security operations. Thus the device compliancy check is rather smooth and simple, still effective.

Further features of, and advantages with, the present invention will become apparent when studying the appended claims and the following description. Those skilled in the art realize that different features of the present invention can be combined to create embodiments other than those described in the following. Many different alterations, modifications and combinations will become apparent for those skilled in the art. The described embodiments are therefore not intended to limit the scope of the invention, as defined by the appended claims.

### BRIEF DESCRIPTION OF THE FIGURES

These and other aspects of the invention will be apparent from and elucidated with reference to the illustrative embodiments shown in the drawings, in which:

FIG. 1 schematically shows a system comprising devices interconnected via a network;

FIG. 2 schematically shows a configuration of a simple device;

FIG. 3 schematically shows a configuration of an enhanced device;

FIG. 4 schematically shows a configuration of an authorized domain manager;

FIG. 5 schematically shows a configuration of a device manager;

FIG. 6 schematically shows a configuration of a rights manager,

FIG. 7 schematically shows a configuration of a content manager;

FIG. 8 schematically shows a certificate chain;

FIG. 9 illustrates which elements are stored in a device;

FIG. 10 summarizes which elements are stored in a device which is part of an existing AD; and

FIG. 11 illustrates the check-in of a device in the AD.

Throughout the figures, same reference numerals indicate similar or corresponding features. Some of the features indicated in the drawings are typically implemented in software, and as such represent software entities, such as software modules or objects.

System Architecture

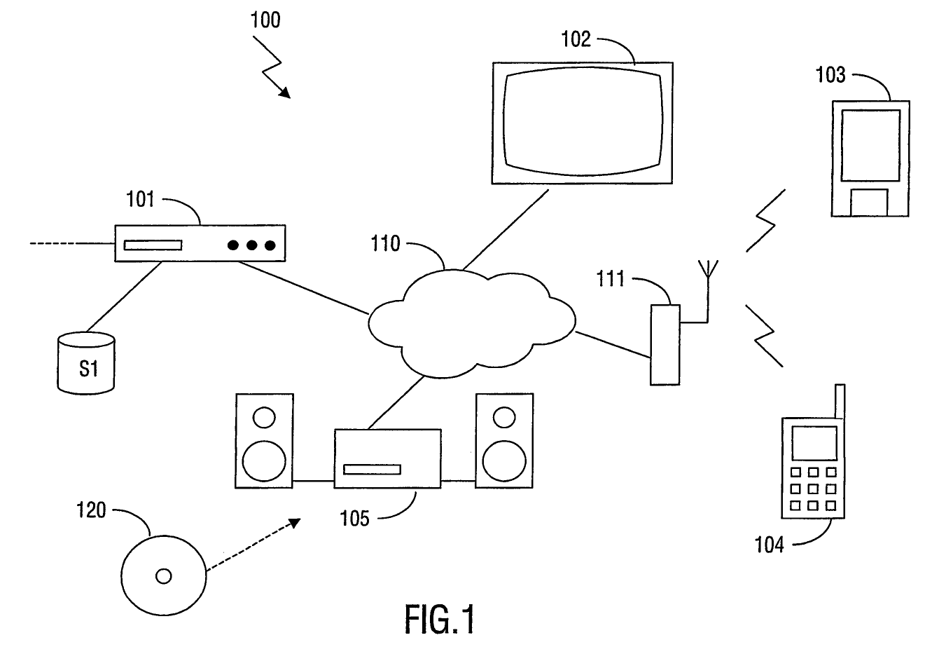

FIG. 1 schematically shows a system 100 comprising devices 101-105 interconnected via a network 110. In this embodiment, the system 100 is an in-home network. A typical digital home network includes a number of devices, e.g. a radio receiver, a tuner/decoder, a CD player, a pair of speakers, a television, a VCR, a tape deck, and so on. These devices are usually interconnected to allow one device, e.g. the television, to control another, e.g. the VCR. One device, such as e.g. the tuner/decoder or a set top box (STB), is usually the central device, providing central control over the others.

Content, which typically comprises things like music, songs, movies, TV programs, pictures, books and the likes, but which also includes interactive services, is received through a residential gateway or set top box 101. Content could also enter the home via other sources, such as storage media as discs or using portable devices. The source could be a connection to a broadband cable network, an Internet connection, a satellite downlink and so on. The content can then be transferred over the network 110 to a sink for rendering. A sink can be, for instance, the television display 102, the portable display device 103, the mobile phone 104 and/or the audio playback device 105.

The exact way in which a content item is rendered depends on the type of device and the type of content. For instance, in a radio receiver, rendering comprises generating audio signals and feeding them to loudspeakers. For a television receiver, rendering generally comprises generating audio and video signals and feeding those to a display screen and loudspeakers. For other types of content a similar appropriate action must be taken. Rendering may also include operations such as decrypting or descrambling a received signal, synchronizing audio and video signals and so on.

The set top box 101, or any other device in the system 100, may comprise a storage medium S1 such as a suitably large hard disk, allowing the recording and later playback of received content. The storage medium S1 could be a Personal Digital Recorder (PDR) of some kind, for example a DVD+RW recorder, to which the set top box 101 is connected. Content can also enter the system 100 stored on a carrier 120 such as a Compact Disc (CD) or Digital Versatile Disc (DVD).

The portable display device 103 and the mobile phone 104 are connected wirelessly to the network 110 using a base station 111, for example using Bluetooth or IEEE 802.11b. The other devices are connected using a conventional wired connection. To allow the devices 101-105 to interact, several interoperability standards are available, which allow different devices to exchange messages and information and to control each other. One well-known standard is the Home Audio/Video Interoperability (HAVi) standard, version 1.0 of which was published in January 2000, and which is available on the Internet at the address http://www.havi.org/. Other well-known standards are the domestic digital bus (D2B) standard, a communications protocol described in IEC 1030 and Universal Plug and Play (http://www.upnp.org).

It is important to ensure that the devices 101-105 in the home network do not make unauthorized copies of the content. To do this, a security framework, typically referred to as a Digital Rights Management (DMR system is necessary. In one such framework, the home network is divided conceptually in a conditional access domain and a copy protection (CP) domain. Typically, the sink is located in the CP domain. This ensures that when content is provided to the sink, no unauthorized copies of the content can be made because of the copy protection scheme in place in the CP domain. Devices in the CP domain may comprise a storage medium to make temporary copies, but such copies may not be exported from the CP domain. This framework is described in European patent application 01204668.6 (attorney docket PHNL010880) by the same applicant as the present application.

Regardless of the specific approach chosen, all devices in the in-home network that implement the security framework do so in accordance with the implementation requirements. Using this framework, these devices can authenticate each other and distribute content securely. Access to the content is managed by the security system. This prevents the unprotected content from leaking “in the clear” to unauthorized devices and data originating from untrusted devices from entering the system.

It is important that devices only distribute content to other devices which they have successfully authenticated beforehand. This ensures that an adversary cannot make unauthorized copies using a malicious device. A device will only be able to successfully authenticate itself if it was built by an authorized manufacturer, for example because only authorized manufacturers know a particular secret necessary for successful authentication or their devices are provided with a certificate issued by a Trusted Third Party.

Device Architecture

An AD is defined as a collection of devices that perform actions with contents according to the rights, which have been defined by content owners. The devices are the central point in this design since they are responsible for enforcing rights that are bound to contents. They manage the AD and perform all the DRM tasks. The devices must still be able to work in an unconnected way, i.e. without any connection to a central server. There are two types of devices in an AD: simple and enhanced devices.

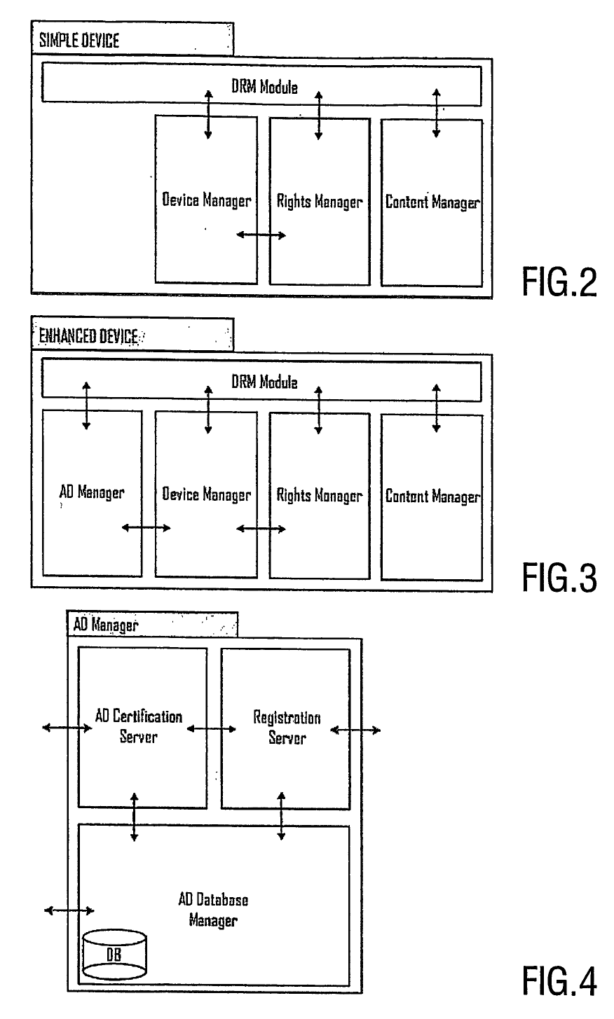

Simple devices do not have much storage, power or processing capacities. They only contain AD Clients, which perform simple DRM tasks. They can render content and are able to interpret and update the corresponding rights. These are typically portable devices, which are often disconnected from the ADM. The configuration of a simple device is given in FIG. 2. The application layer has been omitted in this schema, although it is present in every device. The different components are described below.

Enhanced devices have storage, power and processing capacities. They contain an additional component: the centralized version of the ADM, which is responsible for administrating the domain. If there is more than one enhanced device in an AD, only one uses its ADM functionalities. The others behave like simple devices. These devices are typically set-top boxes, which are generally not moved. The configuration of an enhanced device is given in FIG. 3.

The users are not as important as devices. They are involved in the check-in/out of devices or of other users but are not identified in order to provide an easier use of the system. For reasons that are explained later, users are not part of this implementation.

The media also introduce some problems because of their readrwrite capabilities. They can be seen as static components, which are only used to store contents and rights. They are not included in this implementation.

The contents and the rights are strongly bound. However, in this implementation, we check them in/out and keep them separately. This lets more freedom for later choices. The contents and the rights are processed by devices and are transferred between devices of the same AD. This transfer must be as transparent as possible to the users.

The Authorized Domain Manager (ADM) participates in the check-in of other devices and administrates the AD. In the present invention, the ADM is centralized in one single device. This should not be problematic in In-Home Digital Network (IHDN) because in many situations, there is at least one device which stays in a fixed area.

The ADM is the implementation of the domain manager and the central point of the AD. It is only contained in enhanced devices. Its roles are multiple:
Checking-in devices in the AD
Revoking AD devices
Maintaining a list of devices, rights, media and contents that are in the AD. The list may optionally also contain the status of every entity (available, unavailable, connected, disconnected)
Creating AD certificates for devices and if necessary, Certificate Revocation Lists (CRLs)

The configuration of an ADM is given in FIG. 4. The AD Certification Server is the Certification Authority of the AD. It issues AD certificates for AD devices and CRLs.

The Registration Server is a service, which is used to register every entity in the AD such as content, device, rights or users. The devices can use it to report their content or right lists. This component strongly collaborates with the AD Database Manager.

The AD Database Manager manages a database that contains all the information related to the AD. This consists in lists of entities that are present within the AD. It is accessed by devices to retrieve information about the AD, for instance, when they need a list of all the rights or contents that are currently available in the AD.

A backup of this component and of its (critical) information could be realized e.g. by setting up a master ADM and to have one or more slaves that backup ADM critical information in case of master failure.

Revocation, as handled by the AD Certification Server, can be achieved in several different manners. Two different techniques would be to use so-called black lists (a list of revoked devices) or white lists (a list of un-revoked devices).

In the black list scenario, the device that is to verify the trust of its communication partner, needs to have an up-to-date version of the list and checks whether the ID of the other device is on that list. The advantage of black lists is that the devices are trusted by default and the trust in them is only revoked, if their ID is listed on the revocation list. This list will be initially very small, but it can potentially grow unrestrictedly. Therefore both the distribution to and the storage on CE devices of these revocation lists might be problematic in the long run.

In the white list scenario, a device has to prove to others that it is still on the list of allowed communication partners. It will do this by presenting an up-to-date version of a certificate, which states that the device is on the white list. The white list techniques overcomes the storage problem, by having only a fixed length certificate stored in each device which proves that that device is on the white list. The revocation acts by sending all devices, except for the revoked ones, a new version of the white list certificate. Although now the storage in the devices is limited, the distribution of the white list certificates is an almost insurmountable problem if no efficient scheme is available.

European patent application serial number 02077422.0 (attorney docket PHNL(20543) provides a technique which combines the advantages of black lists (initially small distribution lists) with the main advantage of white lists (limited storage). Preferably, this technique additionally uses a device certificate, which proves the ID of a device. This device certificate is already present in the devices (independent of revocation) as the basis for the initial trust and is installed, e.g., during production in the factory.

Device Manager

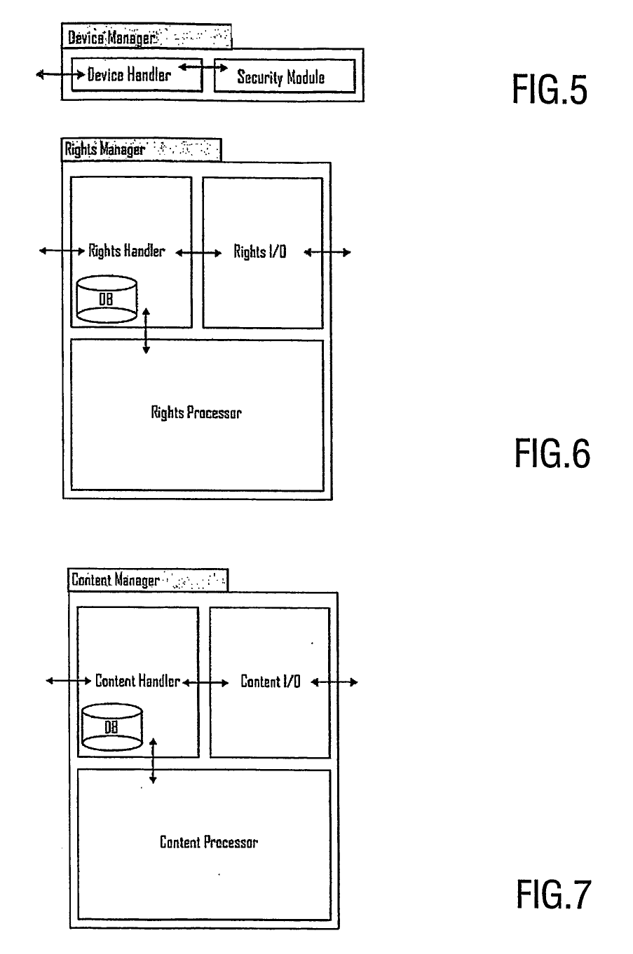

The Device Manager manages all the security objects such as device certificates and private key and can register the device to the ADM. It is also responsible for maintaining the knowledge that a device has about its environment: it stores a list of connected devices and their respective content and right lists. The configuration of the Device Manager is given in FIG. 5.

The Device Handler is the component that maintains all the information concerning the surrounding environment. It stores a list of devices and, optionally, their content and right lists.

The Security Module takes care of all the security information such as encryption keys or device certificates and provides them to other components, especially to the network layer (not represented in these schemes).

Right Manager

The Right Manager is a decentraliz part of the DRM system. It is present in every device and provides the means to interpret, manage and transfer rights. It interacts with the ADM for registering and locating rights. The tasks of the Right Manager include:
Checking-in/out rights
interpreting, updating, deleting, checking validity, storing and transferring rights (between devices)
importing/exporting rights from/to other ADs or proprietary DRM systems

The configuration of a Right Manager is given in FIG. 6. The Right Handler manages a local database of rights. Its tasks include rights retrieval, storage, and deletion. When the application asks the Right Manager about a right availability and/or validity, the Right Handler interacts with the Right Processor to retrieve and interpret the right.

The Right I/O takes care of the importation, export and transfer of rights between devices. Its importation and export functionalities can be extended with Right I/O Plugins to enable a certain level of interoperability with other ADs or proprietary DRM systems.

The Right Processor performs all processing tasks relative to rights, that is:
interpreting and updating rights
checking rights validity
signing rights
encrypting/decrypting secret part of rights, such as content encryption keys
   Content Manager

The Content Manager is very similar to the Right Manager in its structure and tasks. Its tasks are to:
retrieve, store, transfer and process content (with appropriate codecs)
encrypt and decrypt content
import content from conditional access DRM systems
import/export content from/to other ADs or proprietary DRM systems

The configuration of the Content Manager is given in FIG. 7. The Content Handler is very similar to the Right Handler. It manages a local database of contents.

The Content I/O provides the functionalities to transfer content between devices and to import/export content from/to other conditional access DRM systems. When transferring from/to other proprietary systems or ADs, it changes the content protection to make it compliant with the destination domain. In such cases, it uses Content I/O Plugins.

The Content Processor renders, transforms (from one format to another one), encrypts and decrypts content (when necessary). It can also get Content I/O Plugins to extend its functionalities.

DRM Module

The DRM Module is responsible of the other modules inside the devices. It can handle operations for checking-in/out some media, rights or contents in the AD in a connectionless manner (i.e. when the ADM is not available directly). It coordinates the functionalities of all the device components. For instance, when a content is rendered, it calls the Right Manager for a valid right and, if such a right exists, extracts the content protection key from it. Then, it gives the key to the Content Manager, together with a request to render the desired content.

Certificate Chain

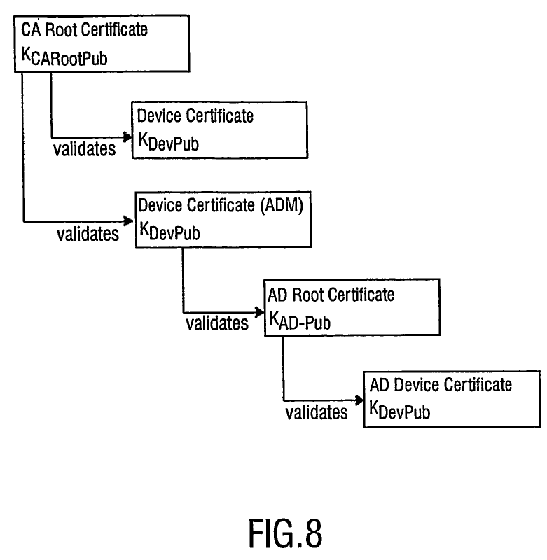

A certificate chain, illustrated in FIG. 8, contains the following certificates: The (external) Certificate Authority (CA) root certificate, self-signed and which is used to sign device certificates.
1. The device certificate, signed by the CA root private key and containing the device public key.
2. The AD root certificate, which is generated by the ADM at AD setup and which signs a new key pair. The private key corresponding to this certificate will be used to issue AD device certificates.
3. The AD device certificate, issued by the ADM when the device joins an AD.
   The reasons that lead to this solution are:
It allows devices to check their respective membership without any connection to the ADM, once they have registered in an AD. This way, they can safely exchange rights without being connected to the ADM.
Regrouping or subgrouping ADs is easily implemented, by adding one or more certificate in the certification path. Of course, this would imply an increased need of secure storage place for every additional element.
The structure is very simple and would be suitable for small CE devices.
There are two ways of removing a device from an AD: to set up a new AD and to refuse this device in this new AD, or to issue a CRL that contains the revoked AD device and to distribute it to all the connected devices.
Critical security elements such as the AD root private key are only stored in one single place, as opposed to other solutions which require the distribution of a shared secret among a set of devices. This decreases the number of points of failure, and therefore, contributes to an increase in the level of security.

The certificates provide the following assurances:
Certificate 1 and 2 ensure device compliancy at manufacturing time
Certificate 3 belongs to the AD manager and enables the creation of an AD
Certificate 4 enables proving of AD membership both online and offline (referring to being connected to the AD manager)
   On Device Certificate Registration

All devices must contain the following elements, which are preferably burned into ROM at manufacturing time:
The certificate of the external CA.
The CA public key.
The device certificate, issued by the external CA, containing the device identity and stating that the device is compliant.
The device private key, corresponding to the public key signed by the external CA in the device certificate.

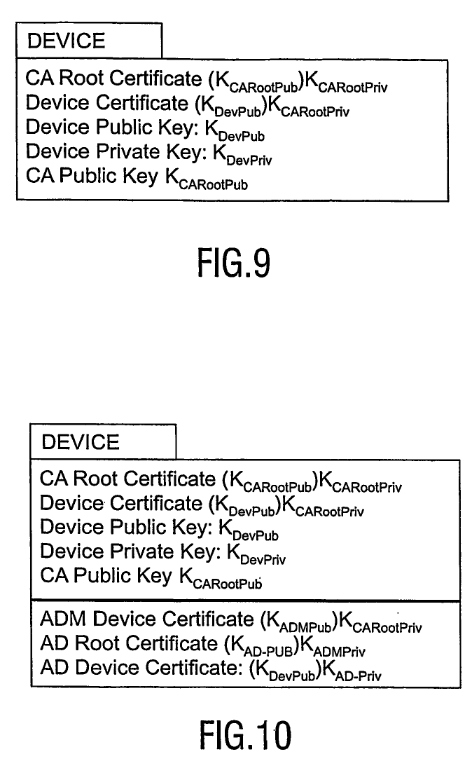

These components are summarized in FIG. 9. They must be kept in a secure storage. The device public key is represented, although it is already contained in the device certificate. Note that the CA public key is included in the CA Root certificate, so it does not necessarily have to be burned into ROM at manufacturing time.

In addition to these elements, a device which is part of an existing AD also stores the following elements, as illustrated in FIG. 10:
An AD device certificate, stating that this device is part of a specific AD. This certificate is signed by the ADM and contains the device public key.
The AD root certificate, which is generated by the ADM during AD setup.
The device certificate of the ADM, signed by the external CA.

These elements are stored in a rewritable location, which must be secure. The devices that are implementing the AD management functionalities additionally store the AD root private key, which is used to issue AD device certificates. The corresponding public key is the AD root public key, contained in the AD root certificate.

AD Management Operations

The ADM uses a factory-installed private key K_{ADMPriv} (synonym for K_{DEVPriv}) to create a local intermediate CA. The ADM issues AD certificates for the key pairs that are already burned into the devices. Devices can check that they belong to the same AD by checking their respective AD certificates. To achieve this, they use the distributed public key of the AD root certificate. Some advantages of this solution are:
K_{ADMPriv}, never changes. This avoids update problems (but can lower the security).
The system can revoke any AD entity in a very simple way.
   AD Setup

The AD setup is performed by an enhanced device, which will be the new ADM. The device does the following:
1. It generates a public/private key pair K_{AD-Priv}/K_{AD-Pub}
2. It creates an AD root certificate for the new key pair and signs it with its factory-installed private key K_{ADMPriv}
3. It stores the created key pair and certificate in a secure place
4. It initializes its databases
5. It asks a user to enter a password, P_{AD}, which will be used to administrate the domain

After this initialization, devices can be added by performing corresponding check-in operations.

Device Check-In

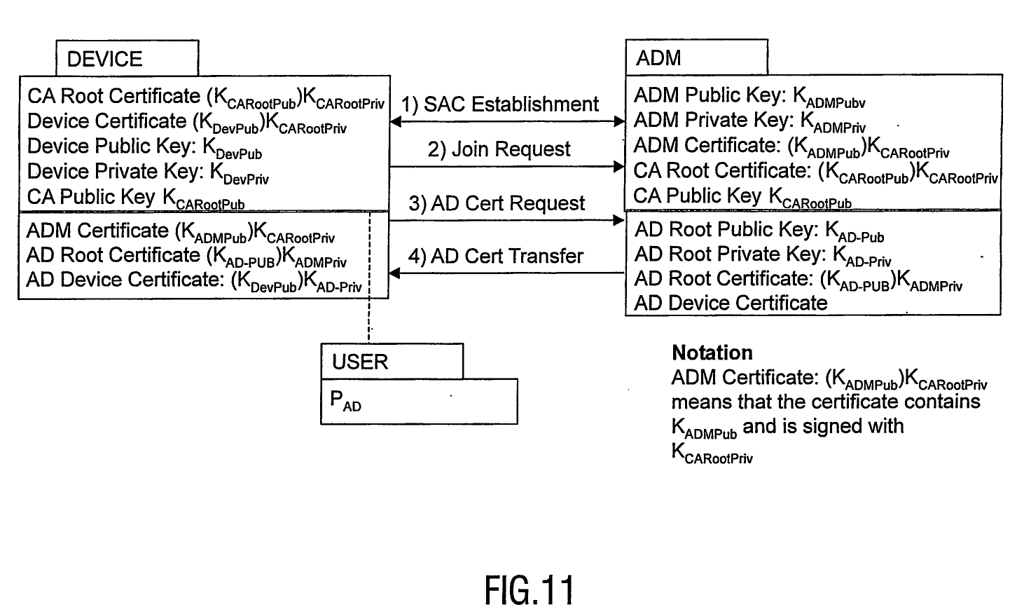

The check-in of a device is illustrated in FIG. 11. Prerequisites for checking-in a device are:
The device is connected to the ADM
A user who knows P_{AD} operates the device
The device can set up a Secure Authenticated Channel (SAC) with the ADM to secure the communication

A SAC allows secure exchange of information between two devices. See e.g. European patent application serial number 02078076.3 (attorney docket PHNL020681). The procedures:
1. The user asks the device to register to the ADM
2. The device and the ADM establish a secure authenticated channel using the device certificates
3. The device asks the user to enter P_{AD}
4. The device transmits the entered password in a join request message
5. The ADM checks the password and request and if valid, signs an AD certificate for the device public key (K_{DeVAPub})
6. The ADM sends the AD certificate back to the device together with the AD root certificate (containing the AD public key K_{AD-Pub})
7. The device stores both certificate and public keys, and the ADM device certificate. They will be needed to validate the certificate chain

After this check-in operation, the device can exchange information with other devices of the AD using its AD certificate to prove its membership.

Device Check-Out

A device check-out operation can occur only when a user operates a device and initializes it. The content and the rights that are stored locally and protected with K_{DevPriv} will not be available anymore, as long as the device does not join the domain again.

The check-out operation is defined by the initialization process that is performed directly on them. The initialization consists only in deleting the device AD certificate from the device memory. Note that the ADM is not involved in device check-out and that this operation automatically excludes the device from being part of the AD because it deletes its AD certificate.

A forced check-out of an AD device out of the AD is also possible. In that case the ADM issues a CRL which lists the AD device certificate belonging to that device.

AD Devices Membership Check

The devices can check that they are in the same AD as another one. This is achieved using AD certificates:
1. Device A sends its AD certificate to Device B and vice-versa
2. Both devices check the certificates (see next section)
3. If the certificates are valid, both devices know that the other device is in same AD
   Certificate Chain Check

In the second point of the membership check, both devices will have to check a certificate chain before declaring that they are in the same AD. The certificates checks that Device A will perform to determinate if Device B is in the same AD are described below. Device A checks (in this order):
1. The AD certificate of Device B using the AD public key K_{AD-Pub}
2. The AD root certificate using the public device key of the ADM K_{ADMPub}
3. The ADM certificate using the public key of the external CA K_{CARootPub}

Stating from the root CA, the chain of trust is built in the following way:
1. The root CA signs the certificate of the ADM
2. The ADM signs a certificate for a new key pair (AD key pair) with its own private key
3. The ADM signs certificates for devices with the AD private key
   Content Check-In

The prerequisite for content check-in is that the content and a corresponding right are present on the same device.

The procedure is:
1. The device picks up a random symmetric key, K_{RandCont} and encrypts the content with it
2. The device encrypts K_{RandCont} with K_{DevPub} and checks the right in (see next section)
3. The device stores the content locally

Note that K_{DevPub} could have been used directly for encrypting the content. An additional symmetric key is chosen, in order to minimize the encryption task, since K_{DevPub} is an asymmetric key. Moreover, when rights are transferred (generally together with the content), this only implies a re-encryption of the keys and not of the rights, which results in less processing tasks.

Right Check-In

The prerequisites for right check-in are:
The content and a corresponding right are present on the same device
K_{RandCont} has already been chosen by the device to encrypt the content The procedure is:
1. The right is translated into an internal AD representation, which includes choosing an internal right identifier. To avoid identifier collisions, this identifier must be bound to the device which performs the check-in operation (for instance to its serial number)
2. The device adds the encrypted version (with K_{DevPub}) of K_{RandCont} in the right and an AD identifier (for instance the AD Root Certificate)
3. The device signs the right using K_{DevPriv}
4. The device stores the right. This right contains an internal representation as well as the complete external right to enable further export to other systems or ADs. The external right is encrypted with K_{RandCont}

The right is bound locally to a specific device. When a right is transferred, its secret parts must be re-encrypted with the public key of the destination device.

Content Play

A content play operation is defined as the rendering action performed on a device. The content play operation is defined as follows:
1. The device retrieves the content and a corresponding right from its local databases
2. The device checks the right validity
3. If the right is valid, the device decrypts the symmetric key which was used to encrypt the content (K_{RandCont}) with its AD private key K_{DevPriv})
4. The device decrypts the content with K_{RandCont} and renders it
5. If the right is subject to number count limitations (such as “play N times”), it is updated and then signed as during right check-in
   Right Interpretation

A right interpretation occurs every time a render operation is performed on content and when a right is copied or moved. It consists in determining the right validity and the operations that can be performed on the right itself.

The interpretation is performed in the following steps:
1. The device checks the right integrity by using K_{DevPub}
2. If the right is not authentic, the device stops the interpretation
3. If the right is authentic, the device interprets it to find if the content can be processed
4. If the content can be processed, the device decrypts and delivers the encryption key K_{RandCont} to the content processor using its private key K_{DevPriv}
   Right Update

A right update occurs when a right has some number count limitations and that the corresponding content is processed. The update process is defined as follow:
1. The device which processes the content updates the right appropriately (in a compliant way)
2. If the right is no longer valid, it is checked out
3. Otherwise, the device computes a hash of the new right and encrypts it with K_{DevPriv}
4. The device replaces the old signed hash by the new one in the right

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer.

In the device claim enumerating several means, several of these means can be embodied by one and the same item of hardware. The mere fact that certain measures are recited in mutually different dependent claims does not indicate that a combination of these measures cannot be used to advantage.

1. A method for secure content distribution among devices (101-105) in a network (110), the method comprising the steps of:
registering, by means of a central device (101) administrating the network, a device (102-105) entering the network (110) and issuing at least one certificate to the entering device (102-105); and
distributing content among devices (101-105) in the network (110) based on authentication by means of the at least one certificate issued to each device (102-105), wherein the distribution of content from a first device (101-105) to a second device (101-105) is enabled by the first device authenticating the second device by means of the at least one certificate of the second device and the second device authenticating the first device by means of the at least one certificate of the first device.

2. The method according to claim 1, wherein the at least one certificate comprises:
a first certificate comprising a public key generated by the central device (101) and a signature created with a device private key; and
a second certificate comprising a public key of the entering device (102-105) and a signature created with a private key generated by the central device (101), said private key generated by the central device (101) corresponding to said public key generated by the central device (101).

3. The method according to claim 1, wherein the step of registering a device (102-105) entering the network (110) comprises:
verifying a third certificate with a device public key stored in each device (101-105), the third certificate being factory installed and signed with a certificate authority private key, wherein verification is performed by means of a factory installed corresponding certificate authority public key; and
authenticating, by means of said device public key, a device (101-105) storing a device private key, said device private key corresponding to said device public key.

4. The method according to claim 2, wherein the step of distributing content among devices (101-105) in the network (110) comprises:
sending the second certificate of the first device (101-105) from the first device to the second device (101-105) and the second certificate of the second device from the second device to the first device;
verifying, using the public key generated by the central device (101), the second certificate of the second device (101-105) at the first device (101-105) and the second certificate of the first device at the second device;
sending the first certificate of the first device from the first device (101-105) to the second device (101-105) and the first certificate of the second device from the second device to the first device;
verifying, using the device public key, the first certificate of the second device (101-105) at the first device (101-105) and the first certificate of the first device at the second device;
sending a third certificate of the central device (101), the third certificate being factory installed and signed with a certificate authority private key, from the first device to the second device (101-105) and sending the third certificate of the central device (101) of the second device to the first device;
verifying, using the certificate authority public key, the third certificate at the second device (101-105) and at the first device (101-105).

5. The method according to claim 1, wherein the central device (101) further performs the steps of:
registering entities contained in the network (110);
storing lists of the entities contained in the network (110); and
issuing a list of deregistered devices in the network (110) to all non-deregistered devices in said network (110).

6. The method according to claim 1, wherein the network is an authorized domain.

7. The method according to claim 1, wherein the network is a home network.

8. A system (100) for secure content distribution among devices (101-105) in a network (110), the system (100) comprising:
a central device (101), which device (101) administrates the network (110), arranged to register a device (102-105) entering the network (110) and arranged to issue at least one certificate to the entering device (102-105); and
at least one certificate, wherein distribution of content among devices (101-105) in the network (110) is based on authentication by means of the at least one certificate issued to each device (102-105), the distribution of content from a first device (101-105) to a second device (101-105) being enabled by the first device authenticating the second device by means of the at least one certificate of the second device and the second device authenticating the first device by means of the at least one certificate of the first device.

9. The system according to claim 8, wherein the at least one certificate comprises:
a first certificate comprising a public key generated by the central device (101) and a signature created with a device private key; and
a second certificate comprising a public key of the entering device (102-105) and a signature created with a private key generated by the central device (101), said private key generated by the central device (101) corresponding to said public key generated by the central device (101).

10. The system according to claim 8, wherein
the central device (101) is arranged to verify a certificate with a device public key stored in each device (101-105), the certificate being factory installed and signed with a certificate authority private key, wherein verification is performed by means of a factory installed corresponding certificate authority public key; and
the central device (101) is arranged to authenticate, by means of said device public key, a device (101-105) storing a device private key, said device private key corresponding to said device public key, when the central device (101) authenticates a device (102-105) entering the network (110).

11. The system according to claim 9, further comprising:
means arranged to send the second certificate of the first device (101-105) from the first device to the second device (101-105) and the second certificate of the second device from the second device to the first device;
means arranged to verify, using the public key generated by the central device (101), the second certificate of the second device (101-105) at the first device (101-105) and the second certificate of the first device at the second device;
means arranged to send the first certificate of the first device from the first device (101-105) to the second device (101-105) and the first certificate of the second device from the second device to the first device;
means arranged to verify, using the device public key, the first certificate of the second device (101-105) at the first device (101-105) and the first certificate of the first device at the second device;
means arranged to send a third certificate of the central device (101), the third certificate being factory installed and signed with a certificate authority private key, from the first device to the second device (101-105) and the third certificate of the central device (101) of the second device to the first device;
means arranged to verify, using the certificate authority public key, the third certificate at the second device (101-105) and at the first device (101-105).

12. The system according to claim 8, wherein the central device (101) further is arranged to:
register entities contained in the network (110);
store lists of the entities contained in the network (110); and
issue a list of deregistered devices in the network (110) to all non-deregistered devices in said network (110).

13. The system according to any one of the claims 8-12, wherein the network is an authorized domain.

14. The system according to claim 8, wherein the network is a home network.

15. A central device (101) for administrating a network (110), the central device (101) comprising:
means arranged to register a device (102-105) entering the network (110); and
means arranged to issue at least one certificate to the entering device (102-105).

16. The central device (101) according to claim 15, further comprising:
means arranged to register entities contained in the network (110);
means arranged to store lists of the entities contained in the network (110); and
means arranged to issue a list of deregistered devices in the network (110) to all non-deregistered devices in said network (110).

17. The central device according to claim 15, wherein the central device is administrating an authorized domain.

18. The central device according to claim 15, wherein the central device is administrating a home network.
